(19) United States
(12) Patent Application Publication
(10) Pub. No.: US 2024/0239043 A1
(43) Pub. Date: Jul. 18, 2024

(54) THREE-DIMENSIONAL PRINTED OBJECTS

(71) Applicant: Hewlett-Packard Development Company, L.P., Spring, TX (US)

(72) Inventors: Emre Hiro Discekici, San Diego, CA (US); Shannon Reuben Woodruff, San Diego, CA (US); Alay Yemane, San Diego, CA (US); Graciela Emma Negri Jimenez, San Diego, CA (US); Mark Kowalski, Corvallis, OR (US); Carolin Fleischmann, San Diego, CA (US)

(21) Appl. No.: 18/289,839

(22) PCT Filed: Jun. 2, 2021
(86) PCT No.: PCT/US2021/035352

§ 371 Date: Nov. 7, 2023

(51) Int. Cl. B29C 64/165; B29C 64/35; B29K 77/00; B29K 105/00; B33Y 10/00; B33Y 40/20; B33Y 70/10

(52) U.S. Cl. CPC B29C 64/165; B29C 64/35; B33Y 40/20; B33Y 70/10; B29K 2077/00; B29K 2105/005; B29K 2995/0072; B33Y 10/00

(57) ABSTRACT

A three-dimensional printed object can include a fused polyamide body having electromagnetic radiation absorber embedded as particles within the fused polyamide body, and the three-dimensional printed object can further include residual benzyl alcohol soaked into a surface of the polyamide body.

### BACKGROUND

Methods of three-dimensional (3D) digital printing, a type of additive manufacturing, have continued to be developed over the last few decades. However, systems for three-dimensional printing have historically been expensive, though expenses have been coming down to more affordable levels recently. Three-dimensional printing technology can shorten the product development cycle by allowing rapid creation of prototype models for reviewing and testing, but the concept has been somewhat limited as it relates to commercial production capabilities because the range of materials used in three-dimensional printing is likewise limited. Accordingly, it can be a challenge to three-dimensionally print functional parts with desired physical properties, such as enhanced mechanical properties, surface smoothness, etc.

### BRIEF DESCRIPTION OF THE DRAWINGS

FIG. 1 is a schematic view of an example three-dimensional printed object in accordance with the present disclosure:

FIG. 2 is a flow diagram illustrating example methods of enhancing smoothness of a three-dimensional printed objects in accordance with the present disclosure:

FIG. 3 provides example graphical schematics depicting methods in accordance with the present disclosure;

FIG. 4 is a flow diagram illustrating example methods of three-dimensional printing in accordance with the present disclosure:

FIGS. 5A-5D provides example graphical schematics depicting methods in accordance with the present disclosure:

FIG. 6 provides optical micrographs depicting an example three-dimensional printed object with enhanced smoothness after treating with a soaking fluid compared to a similar control object that was not treated with the soaking fluid in accordance with the present disclosure;

FIG. 7 is a bar graph illustrating example overall stiffness or elastic modulus data of a three-dimensional printed objects compared to the same three-dimensional printed objects after being heated in a soaking fluid in accordance with the present disclosure;

FIG. 8 is a bar graph illustrating example ductility or elongation data of a three-dimensional printed objects compared to the same three-dimensional printed objects after being heated in soaking fluid in accordance with the present disclosure: and

FIG. 9 is a bar graph illustrating example tensile strength data of a three-dimensional printed objects compared to the same three-dimensional printed objects after being heated in soaking fluid in accordance with the present disclosure.

### DETAILED DESCRIPTION

Three-dimensionally printing that utilizes heat fusing of polymeric particles can provide a convenient way to prepare three-dimensional objects, but in some cases, may not result in an object being as smooth as may be desired for a given application. Three-dimensional objects can be treated after printing using heat and a post-print soak with a soaking fluid to assist with smoothing out the polymeric surface. A post-print treatment with a soaking fluid including benzyl alcohol (which is a non-hazardous compound) can enhance the smoothness of polyamide polymer objects in a relatively short period of time, often with little to no object distortion when carried out appropriately.

In accordance with examples of the present disclosure, three-dimensional printed objects include a fused polyamide body having electromagnetic radiation absorber embedded as particles within the fused polyamide body, and residual benzyl alcohol soaked into a surface of the polyamide body. In some examples, the electromagnetic radiation absorber can be selected from carbon black pigment, metal dithiolene complex, a near-infrared absorbing dye, a near-infrared absorbing pigment, metal nanoparticles, a conjugated polymer, tungsten bronze, molybdenum bronze, or a combination thereof. In other examples, the fused polyamide body can include polyamide-6, polyamide-9, polyamide-11, polyamide-12, polyamide-6,6, polyamide-6,12, thermoplastic polyamide, amorphous polyamide, thermoplastic polyamide elastomer, polyamide copolymer, e.g., polyvinylidene fluoride copolyamide-12, or a combination thereof. The three-dimensional printed object can have a surface roughness from about 1 μm to about 8 μm, for example.

Methods of enhancing smoothness of a three-dimensional printed object include soaking a three-dimensional printed object in a soaking fluid including from about 50 wt % to 100 wt % benzyl alcohol at a temperature from about 50° C. to about 205° C. for a period of time of about 10 seconds to about 15 minutes. The three-dimensional printed object includes a fused polyamide body and electromagnetic radiation absorber particles dispersed within the fused polyamide body. In some examples, the electromagnetic radiation absorber particles can be carbon black pigment, metal dithiolene complex, a near-infrared absorbing dye, a near-infrared absorbing pigment, metal nanoparticles, a conjugated polymer, tungsten bronze, molybdenum bronze, or a combination thereof. In other examples, the fused polyamide body can include polyamide-6, polyamide-9, polyamide-11, polyamide-12, polyamide-6,6, polyamide-6,12, thermoplastic polyamide, amorphous polyamide, thermoplastic polyamide elastomer, polyamide copolymer, e.g., polyvinylidene fluoride copolyamide-12, or a combination thereof. Prior to soaking, the three-dimensional printed object can have a surface roughness from about 10 to about 20 prior to soaking. After soaking, the three-dimensional object can have a surface roughness from about 1 μm to about 8 μm. In other examples, after soaking, the three-dimensional printed object can have reduced stiffness and enhanced elongation at break compared to the three-dimensional object prior to soaking. In further detail, residual benzyl alcohol can be soaked into a surface of the three-dimensional printed object.

Methods of three-dimensional printing include iteratively applying individual polymer build material layers of polyamide particles to a powder bed, and based on a three-dimensional object model, selectively applying a fusing agent onto the individual polymer build material layers, wherein the fusing agent comprises water and an electromagnetic radiation absorber. The methods also include exposing the powder bed to electromagnetic energy to selectively fuse the polyamide particles in contact with the electromagnetic radiation absorber to form the fused polyamide body having the electromagnetic radiation absorber particles dispersed therein and soaking the fused polyamide body in a soaking fluid including benzyl alcohol to form a smoothed three-dimensional printed object. In some examples, the soaking fluid can include from about 50 wt % to 100 wt % benzyl alcohol. The methods can further include washing the surface of the three-dimensional printed object after soaking. In other examples, residual benzyl alcohol can be soaked into a surface of the three-dimensional printed object. The fused polyamide body can have a surface roughness from about 10 μm to about 20 μm prior to soaking, and after soaking the three-dimensional object can have a surface roughness from about 1 μm to about 6 μm, for example.

It is noted that when discussing the three-dimensional printed objects and/or related methods, these discussions can be considered applicable to one another whether or not they are explicitly discussed in the context of that example. Thus, for example, when discussing a fusing agent related to a three-dimensional printed object, such disclosure is also relevant to and directly supported in the context of the methods and vice versa.

It is also understood that terms used herein will take on their ordinary meaning in the relevant technical field unless specified otherwise. In some instances, there are terms defined more specifically throughout the specification or included at the end of the present specification, and thus, these terms have a meaning as described herein.

### Three-Dimensional Printed Objects

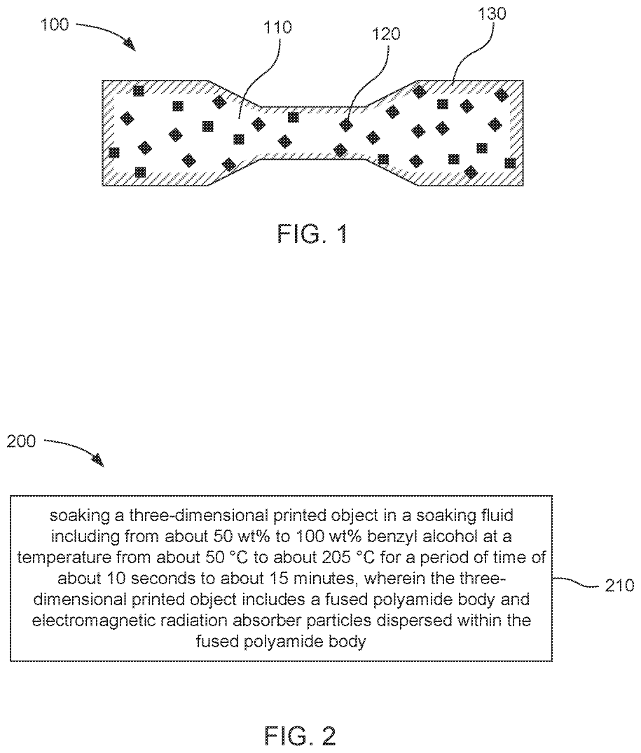

A three-dimensional printed object 100 is shown in FIG. 1, which can include a fused polyamide body 110 having electromagnetic radiation absorber 120 embedded as particles within the fused polyamide body, and residual benzyl alcohol imbibed or soaked 130 into a surface of the polyamide body. In some examples, the electromagnetic radiation absorber can be selected from carbon black pigment, metal dithiolene complex, a near-infrared absorbing dye, a near-infrared absorbing pigment, metal nanoparticles, a conjugated polymer, tungsten bronze, molybdenum bronze, etc., as set forth in greater detail hereinafter. The fused polyamide body can include, for example, polyamide-6, polyamide-9, polyamide-11, polyamide-12, polyamide-6,6, polyamide-6,12, thermoplastic polyamide elastomer, amorphous polyamide, polyamide copolymer, e.g., polyvinylidene fluoride copolyamide-12, or a combination thereof. The benzyl alcohol can be soaked into the surface of the fused polyamide body at a depth from about 500 nm to about 5 mm, from about 1 μm to about 3 mm, from about 100 μm to about 2 mm, or from about 200 μm to about 1 mm, for example. In further detail, the three-dimensional printed object 100 can have a surface roughness from about 1 μm to about 8 μm, from about 1 μm to about 6 μm, from about 1 μm to about 4 μm, from about 2 μm to about 8 μm, or from about 2 μm to about 6 μm, for example. Surface roughness, for example, can be measured using a Mitutoyo surface roughness gage measured in average micron size.

The residual benzyl alcohol 130 soaked or imbibed in the surface of the polyamide body 110, which can be carried out as described herein after by surface soaking, can provide mechanical property modifications to the three-dimensional printed object 100 prior to imbibing the benzyl alcohol into the surface. For example, the three-dimensional printed object can exhibit reduced stiffness and/or enhanced elongation at break compared to the three-dimensional object having the same dimensions and material, other than the presence of the residual benzyl alcohol soaked in the surface of the three-dimensional printed object. As an example, in some experiments, the stiffness with the benzyl alcohol soaked into a surface of the fused polyamide body may exhibit from about 2 times to about 6 times reduced stiffness based on Young's Modulus values (MPa). In some experiments, the elongation at break (or strain at break) may be increased by about 1.2 times to about 2 times based on % elongation in length prior to failure. These values can be obtained based on a dog bone or barbell shaped part (not to scale but similar to that shown in FIG. 1). These mechanical properties can be determined using an Instron tensiometer in accordance with DIN 53504:2009-10 using Type S2 dog bones (or barbells), for example.

### Methods of Enhancing Smoothness of Three-Dimensional Printed Objects

Referring now to FIG. 2, methods 200 of enhancing smoothness of a three-dimensional printed object can include soaking 210 a three-dimensional printed object in a soaking fluid including from about 50 wt % to 100 wt % benzyl alcohol at a temperature from about 50° C. to about 205° C. for a period of time of about 10 seconds to about 15 minutes. The three-dimensional printed object can include a fused polyamide body and electromagnetic radiation absorber particles dispersed within the fused polyamide body. In some examples, the electromagnetic radiation absorber particles and the fused polyamide body can be as described previously with respect to the three-dimensional printed object, for example. Soaking the fused polyamide body with the dispersed electromagnetic radiation absorber particles in the soaking solution can provide multiple benefits, including enhanced surface smoothness and/or enhanced mechanical properties. Regarding surface roughness, prior to soaking, the three-dimensional printed object can have a surface roughness from about 10 to about 20, and after soaking, the three-dimensional object has a surface roughness from about 1 μm to about 8 μm, from about 1 μm to about 6 μm, from about 1 μm to about 4 μm, from about 2 μm to about 8 μm, or from about 2 μm to about 6 μm, for example. Surface roughness, for example, can be measured using a Mitutoyo surface roughness gage measured in average micron size. In further detail, after soaking, the three-dimensional printed object can have reduced stiffness and enhanced elongation at break compared to the three-dimensional object prior to soaking. These mechanical properties can be determined using an Instron tensiometer in accordance with DIN 53504:2009-10 using Type S2 dog bones (or barbells), for example.

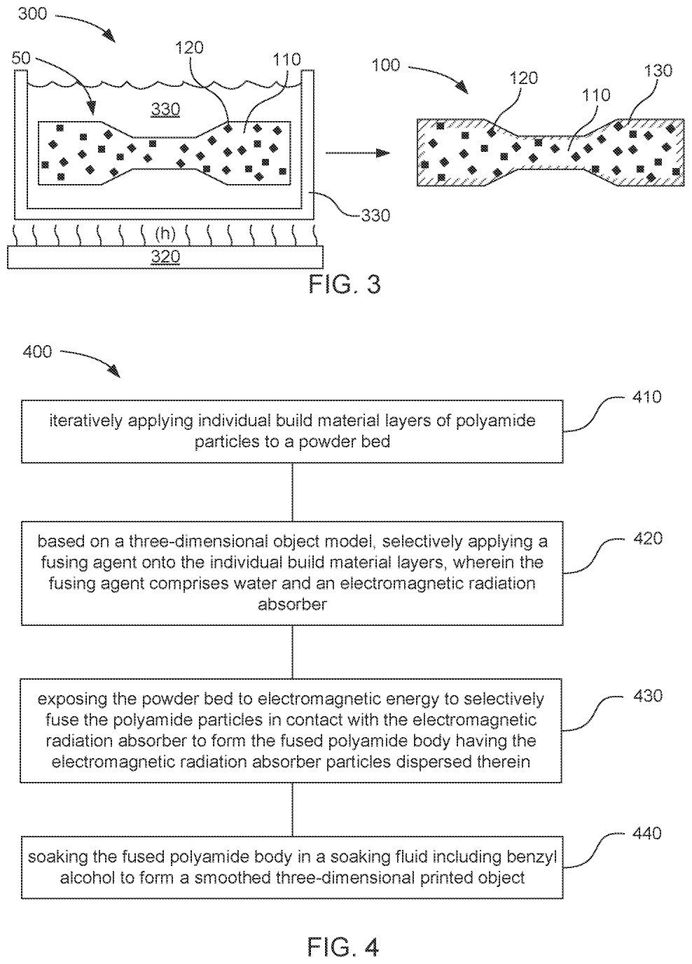

FIG. 3 provides an example graphical sequential schematic depicting one method in accordance with FIG. 2 of the present disclosure as shown at 300. In some examples, a soaking fluid 330 that includes benzyl alcohol can be used to soak a fused polyamide body 110 with electromagnetic radiation absorber 120 embedded as particles therein. The resulting object can be a three-dimensional printed object 100 with the fused polyamide body and the electromagnetic radiation absorber with residual benzyl alcohol 130 soaked into a surface thereof. Though the residual benzyl alcohol from the soaking fluid is shown having soaked into the fused polyamide body a certain depth, this is shown by way of example only. In some examples, the residual benzyl alcohol may soak less than or deeper into the polymeric body, depending on the porous nature of the fused polyamide body, the soaking fluid formulation used, the amount of soaking time, the temperature, etc.

Regarding temperature and time of soaking, in some examples the soaking can be under elevated temperature or heat (h) from a heating source 320 to bring the temperature to from about 50° C. to about 205° C. for a period of time sufficient to smooth a surface of the three-dimensional object, and in many instances, imbibe the surface with residual benzyl alcohol. Other temperature ranges that can be selected for use can be from about 60° C. to about 175° C., from about 70° C. to about 150° C., or from about 70° C. to about 125° C., for example. Example time frames for application of heat, if heat is applied, can depend on the temperature used, but time frames can be from about 10 seconds to about 15 minutes, from about 30 seconds to about 10 minutes, or from about 1 minute to about 5 minutes, for example. To illustrate, an 8 to 12 minute soak in 100 wt % benzyl alcohol at from about 70° C. to about 90° C. can be used to smooth the surface of a fused polyamide body from having an average surface roughness (or surface roughness) from about 11 μm to about 14 μm, resulting in a fused polyamide body of the three-dimensional printed object having an average surface roughness averaging from about 2 μm to about 5 μm. Likewise, the mechanical strength from using the same parameters may be useful in enhancing the mechanical strength. By way of examples, stiffness may be decreased from about 31 MPa to about 38 MPa to within a range from about 8 MPa to about 10 MPa, which is within the range of about a 2 times to about a 6 times decrease in stiffness, and more particularly, about a 3 times to about a 4 times decrease in stiffness in this more specific example. In further detail regarding the soaking fluid 330, this is a fluid that includes benzyl alcohol. In some examples, the soaking fluid can include from about 50 wt % to 100 wt % benzyl alcohol, from about 75 wt % to 100 wt % benzyl alcohol, from about 90 wt % to 100 wt % benzyl alcohol, from about 95 wt % to 100 wt % benzyl alcohol, or about 100 wt % benzyl alcohol. If there are other fluid components in the soaking fluid other than the benzyl alcohol, example fluids can include water, other organic cosolvent, or surfactant, for example.

The soaking fluid can be applied using an application unit, which can include equipment for applying the soaking fluid to the fused polyamide body or three-dimensional printed object. A soaking fluid application unit can include a tank 330 or well containing the soaking fluid for dipping a three-dimensional printed object or sprayers (not shown) for spraying the soaking fluid onto a three-dimensional printed object. In certain examples, the soaking fluid application unit can include a chamber in which a three-dimensional object can be enclosed and internal sprayers within the chamber can apply the soaking fluid to the three-dimensional printed object. Thus, the term “soaking” does not infer that the three-dimensional object is being bathed in the soaking fluid (though it may be), but rather that a coating is applied and remains on a surface of the three-dimensional object for the time period of the soaking so that the benzyl causes smoothing of the fused polyamide body or object surface and in many instances can absorb or be soaked into the surface during the soaking duration.

Washing excess soaking fluid from the three-dimensional printed object after soaking can be carried out in some examples. The soaking fluid application unit can also include equipment to wash the object, such as with water, soap and water, or with other solvent solutions that may be suitable for removing residual benzyl alcohol from the surface of the three dimensional printed object. Alternatively, the three-dimensional printed object can be removed from the soaking fluid application unit and washed elsewhere. In certain examples, a separate washing unit can be used.

### Methods of Three-Dimensional Printing

In further detail, three-dimensional printed objects can be prepared in accordance with methods 400 of three-dimensional printing as shown by way of example in FIG. 4. The methods include iteratively applying 410 individual polymer build material layers of polyamide particles to a powder bed, and based on a three-dimensional object model, selectively applying 420 a fusing agent onto the individual polymer build material layers, wherein the fusing agent comprises water and an electromagnetic radiation absorber. The methods further include exposing 430 the powder bed to electromagnetic energy to selectively fuse the polyamide particles in contact with the electromagnetic radiation absorber to form the fused polyamide body having the electromagnetic radiation absorber particles dispersed therein, and soaking 440 the fused polyamide body in a soaking fluid including benzyl alcohol to form a smoothed three-dimensional printed object. In some examples, the soaking fluid can include from about 50 wt % to 100 wt % benzyl alcohol. In some examples, the methods can further include washing the surface of the three-dimensional printed object after soaking. In other examples, residual benzyl alcohol can be soaked into a surface of the three-dimensional printed object. The fused polyamide body can have a surface roughness from about 10 μm to about 20 μm prior to soaking, and after soaking, the three-dimensional object has a surface roughness from about 1 μm to about 8 μm, for example.

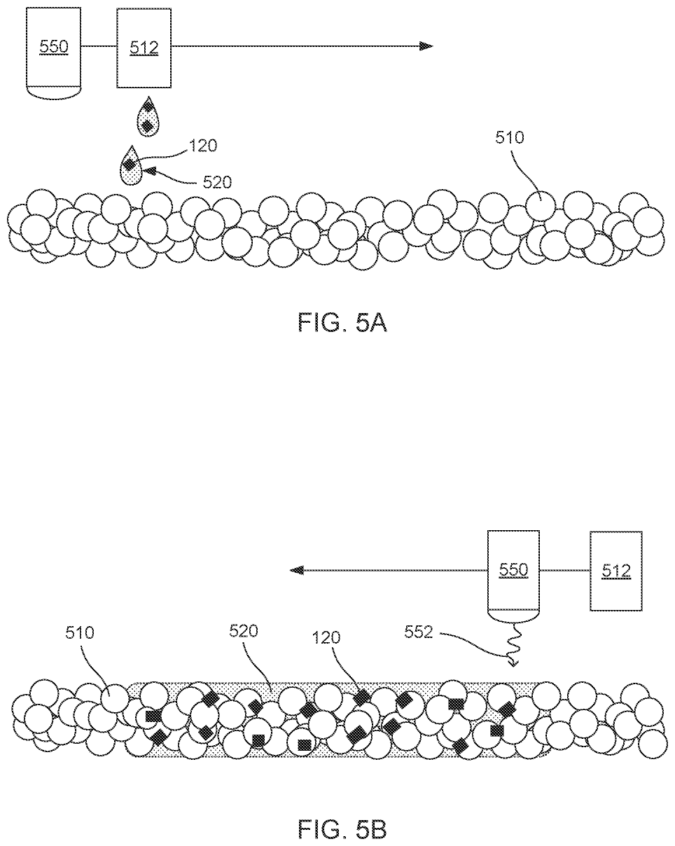

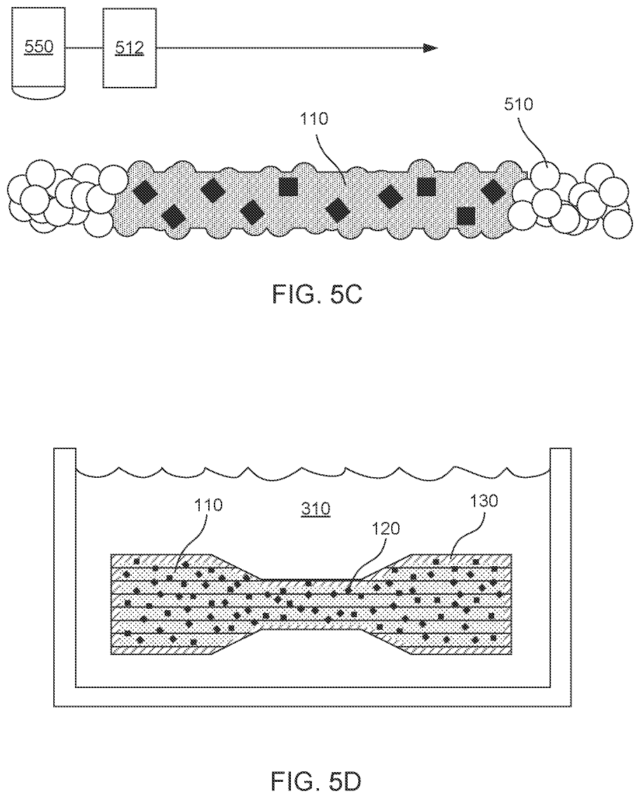

FIGS. 5A-5D provide an example graphical sequential schematic depicting one method in accordance with FIG. 4 of the present disclosure. This method can be used, In some examples, to prepare the three-dimensional printed object shown in FIG. 1, or in other examples, can be used in conjunction with the methods of enhancing smoothness of a three-dimensional printed object as shown in FIGS. 2 and 3. In some examples, the soaking fluid can be applied to the surface of the three-dimensional printed object by dipping, spraying, brushing, or otherwise applying to provide a surface soaked with the soaking fluid, provided the soaking fluid or at least the benzyl alcohol remains in contact with the surface of the three-dimensional object during the duration of the soak.

To illustrate one example method of forming the three-dimensional printed object, as shown in FIG. 5A, a fusing agent 520 containing an electromagnetic radiation absorber 120 can be applied, e.g., jetted, onto a layer of polymer build material 510, which is part of a powder bed including from about 80 wt % to 100 wt % polyamide particles. The fusing agent can be jetted from a fusing agent ejector 512 that can move across the layer of polymer build material to selectively jet fusing agent on areas that are to be fused. A radiation source 550 is also shown, which is described in more detail in the context of FIG. 5B. In further detail, the materials used for carrying out this method can be part of a three-dimensional printing kit that includes the polymer build material, the fusing agent, and/or a soaking fluid (shown in FIG. 5D). Likewise, this materials kit can be used in a three-dimensional printing system that includes the fusing agent ejector and the radiation source, for example.

Referring to FIG. 5B, after the fusing agent 520 has been jetted onto an area of the layer that is to be fused as shown, which includes the electromagnetic radiation absorber 120 dispersed as particles, a radiation source 550 can emit electromagnetic radiation 552 toward the layer of polymer build material, which includes the polyamide particles. The fusing agent can include any of the radiation absorbers previously described, provided it can absorb this radiation and convert the electromagnetic radiation emitted to heat.

In further detail, the polymer build material 510 of polyamide particles can be preheated to a preheat temperature within about 10° C. to about 70° C. of the fusing temperature of the polyamide particles. In some examples, the powder bed of polymer build material as a whole can be preheated to a temperature below the melting or softening point of the polyamide particles. In some examples, the preheat temperature can be from about 10° C. to about 30° C. below the melting or softening point. In other examples, the preheat temperature can be within 50° C. of the melting or softening point. Depending on the type of polyamide particles used, the preheat temperature can be in the range of about 50° C. to about 200° C. or more. In some examples, the entire powder bed can be heated to a substantially uniform temperature. Preheating can occur from any source, such as a build platform (not shown) or an overhead heating lamp (not shown). At this pre-heated state, the electromagnetic radiation 552 can be applied from the radiation source 550 to raise the temperature of the radiation absorber of the fusing agent, and thus, further heat the printed portion of the polymer build material. Suitable radiation sources that may be used include fusing lamps, such as commercially available infrared lamps or halogen lamps. The fusing lamp can be a stationary lamp or a moving lamp. For example, the lamp can be mounted on a track to move horizontally across the powder bed. Such a fusing lamp can make multiple passes over the bed depending on the amount of exposure to coalesce printed layers. The fusing lamp can be configured to irradiate the entire powder bed with a substantially uniform amount of energy. This can selectively coalesce the printed portions with fusing agent leaving the unprinted portions of the polyamide particles below the melting or softening point.

In some examples, the radiation source 550, e.g., fusing lamp, can be matched with the radiation absorber 120 in the fusing agent 520 so that the fusing lamp emits electromagnetic radiation 512 having a wavelength of light that matches the peak absorption wavelength or other suitable absorption profile of the radiation absorber sufficient to cause the polyamide particles to become fused on a layer-by-layer basis. A radiation absorber with a narrow peak at a particular near-infrared wavelength can be used with a fusing lamp that emits a narrow range of wavelengths at approximately the peak wavelength of the radiation absorber. Similarly, a radiation absorber that absorbs a broad range of near-infrared wavelengths can be used with a fusing lamp that emits a broad range of wavelengths. Matching the radiation absorber and the fusing lamp in this way can increase the efficiency of coalescing the polyamide particles with the fusing agent printed thereon, while the unprinted polyamide particles do not absorb as much light and remain at a lower temperature.

Depending on the amount of radiation absorber present in the polyamide particles, the absorbance of the radiation absorber, the preheat temperature, and the melting or softening point of the polymer, an appropriate amount of irradiation can be supplied from the fusing lamp. In some examples, the fusing lamp can irradiate individual layers from about 0.5 to about 10 seconds per pass.

FIG. 5C shows a layer of polymer build material 510 where a fused portion becomes a layer of the fused polyamide body 110 where the fusing agent was jetted. In other words, this portion has reached a sufficient temperature to fuse the polymer build material (including the polyamide particles) together to form a layer of the fused polyamide body having the electromagnetic radiation absorber particles 120 embedded therein. For context, the fusing agent ejector 512 and the radiation source 550 are shown in place to apply the next applications of fusing agent and radiation to the next layer of polymer build material applied thereon, to thereby continue to build the three-dimensional object iteratively. Once the three-dimensional object is formed in a layer-by-layer manner, it can be removed and soaked in a soaking fluid 330 that includes benzyl alcohol, as shown in FIG. 5D, under conditions previously described, such as under heat for a period of time to imbibe the surface with residual benzyl alcohol 130.

Referring further to the process described in FIGS. 5A-5C (prior to soaking in benzyl alcohol), the three-dimensional printed object can be formed by jetting a fusing agent onto layers of powder bed build material according to a three-dimensional object model. Three-dimensional object models can in some examples be created using computer aided design (CAD) software. Three-dimensional object models can be stored in any suitable file format. In some examples, a three-dimensional printed object as described herein can be based on a single three-dimensional object model. The three-dimensional object model can define the three-dimensional shape of the object. Other information may also be included, such as structures to be formed of additional different materials or color data for printing the object with various colors at different locations on the object. The three-dimensional object model may also include features or materials specifically related to jetting fluids on layers of polymer build material, such as the desired amount of fluid to be applied to a given area. This information may be in the form of a droplet saturation, for example, which can instruct a three-dimensional printing system to jet a certain number of droplets of fluid into a specific area. This can allow the three-dimensional printing system to finely control radiation absorption, cooling, color saturation, and so on. All this information can be contained in a single three-dimensional object file or a combination of multiple files. The three-dimensional printed object can be made based on the three-dimensional object model. As used herein, “based on the three-dimensional object model” can refer to printing using a single three-dimensional object model file or a combination of multiple three-dimensional object models that together define the object. In certain examples, software can be used to convert a three-dimensional object model to instructions for a three-dimensional printer to form the object by building up individual layers of build material.

In an example of the three-dimensional printing process, a thin layer of polyamide particles can be spread on a bed to form a powder bed. At the beginning of the process, the powder bed can be empty because no polyamide particles have been spread at that point, or the first layer can be applied onto an existing powder bed, e.g., support powder that is not used to form the three-dimensional object. For the first layer, the polyamide particles can be spread onto an empty build platform. The build platform can be a flat surface made of a material sufficient to withstand the heating conditions of the three-dimensional printing process, such as a metal. Thus, “applying” individual polymer build material layers of polyamide particles to a powder bed includes spreading polyamide particles onto the empty build platform for the first layer, followed by subsequently applied layers of polymer build material, and so forth. In some examples, a number of initial layers of polyamide particles can be spread before the printing begins (either one at a time or in bulk). These “blank” layers of polymer build material can in some examples number from about 10 to about 500, from about 10 to about 200, or from about 10 to about 100. In some cases, spreading multiple layers of powder before beginning the printing process can increase temperature uniformity of the three-dimensional printed object. A fluid jet printing head, such as an inkjet print head, can be used to print a fusing agent including a radiation absorber over portions of the powder bed corresponding to a thin layer of the three-dimensional object to be formed. The powder bed can be exposed to electromagnetic energy, e.g., typically the entire bed. The electromagnetic energy can include light, infrared radiation, and so on. The radiation absorber can absorb more energy from the electromagnetic energy than the unprinted powder. The absorbed light energy can be converted to thermal energy, causing the printed portions of the powder to soften and fuse together into a formed layer. After the first layer is formed, a new thin layer of polyamide particles can be spread over the powder bed and the process can be repeated to form additional layers until a complete three-dimensional object is printed. Thus, applying the individual build material layers of polyamide particles to a powder bed also includes spreading layers of polyamide particles over the loose particles and fused layers beneath the new layer of polyamide particles.

After the three-dimensional object has been initially formed using the process shown by example in FIGS. 5A-5C, the three dimensional object can be treated with the soaking fluid of benzyl alcohol shown in FIG. 5D using any of a number of soaking application methods. For example, the object can be dipped in soaking fluid for a period of time, sprayed, brushed, etc. In some examples, the methods can also include washing excess soaking fluid from the three-dimensional printed object, such as using water, soap and water, organic solvent, organic solvent and water, etc. In various examples, the object can be washed by spraying, soaking, scrubbing, or other methods.

### Polymer Build Materials

The three-dimensional printing processes described can utilize a polymer build material that includes polyamide particles. Polyamide particles can include a variety of polymers that include polymerized monomers linked together by amide linkages. The benzyl alcohol when applied while soaking can have a solubilizing effect on polyamide polymers, thus enhancing the smoothness of the surface, but can also lead to enhanced mechanical properties, such as enhanced elasticity as evidenced by % strain at break data, as well as a decrease in stiffness, as evidenced by Young's Modulus data. Polyamide polymers that can be used as the polyamide particles (to form the fused polyamide body described previously) can include polyamide-6, polyamide-9, polyamide-11, polyamide-12, polyamide-6,6, polyamide-6,12, thermoplastic polyamide elastomer, amorphous polyamide, polyamide copolymer, e.g., polyvinylidene fluoride copolyamide-12, or a combination thereof. In some examples, the polyamide particles can be made up entirely of a single type of polyamide polymer. In other examples, a mixture of two or more types of polyamide polymers can be used. In still other examples, a mixture of polymer particles including the polyamide particles of a second type of polymer particle (not a polyamide particle) or even a non-polymeric filler can be used. Typically, the polyamide particles can be present at from about 80 wt % to 100 wt % of the powder bed based on the polymer build material content.

If there are other particles present as part of the polymer build material (or powder bed) other than polyamide particles, such as an alternative type of polymer or even a non-polymeric filler, examples of polymer particles that can be used may include, polyethylene, wax, thermoplastic polyurethane, acrylonitrile butadiene styrene, amorphous polyamide, polymethylmethacrylate, ethylene-vinyl acetate, polyarylate, aromatic polyesters, silicone rubber, polypropylene, polyester, polycarbonate, copolymers of polycarbonate with acrylonitrile butadiene styrene, copolymers of polycarbonate with polyethylene terephthalate, polyether ketone, polyacrylate, polystyrene, polyvinylidene fluoride, poly(vinylidene fluoride-trifluoroethylene), poly(vinylidene fluoride-trifluoroethylene-chlorotrifluoroethylene), mixtures thereof, or the like. If other types of fillers are used, examples can include inorganic particles such as alumina, silica, fibers, carbon nanotubes, or combinations thereof. When the polyamide particles fuse together, the filler particles can become embedded in the polymer, forming a composite material. In some examples, the filler can include a free-flow agent, anti-caking agent, or the like. Such agents can prevent packing of the powder particles, coat the powder particles and smooth edges to reduce inter-particle friction, and/or absorb moisture. In some examples, the filler particles can be included in the polymer build material of the powder bed at about 0.01 wt % to about 20 wt %, from about 0.1 wt % to about 10 wt %, or from about 0.2 wt % to about 5 wt %, for example, based on the total weight of the polymer build material.

In certain examples, the polymer build material of the powder bed can include the polyamide particles (and in some instances other types of particles blended therewith) having a variety of shapes, such as spherical particles (average aspect ratio of about 1:1) or irregularly-shaped particles (average aspect ratios of about 1:1 to about 1:2). Other average aspect ratios can also be used, e.g., from about 1:1.2 to about 1:5, from about 1:1.5 to about 1:3, etc. If other particles are present, they can have a similar or different aspect ratio relative to the polyamide particles.

The polymer build material can be formed into three-dimensional printed objects with a resolution of about 20 μm to about 150 μm, about 20 μm to about 100 μm, about 30 μm to about 90 μm, or about 40 μm to about 80 μm. As used herein, “resolution” refers to the size of the smallest feature that can be formed on a three-dimensional printed object. To achieve this resolution, the polymer powder can have an average particle size from about 10 μm to about 150 μm, from about 20 μm to about 100 μm, from about 30 μm to about 90 μm, from about 40 μm to about 80 μm, or from about 20 μm to about 50 μm, for example. With smaller average particle sizes, there can be more flexibility regarding how thick the individual layers may be, for example. For example, in alignment with the resolutions described above, the polymer powder can form layers from about 20 μm to about 150 μm thick, or any of the sub-range resolutions mentioned above. This can provide a resolution in the z-axis direction (e.g., depth or direction of three-dimensional object build-up) of about 20 μm to about 150 μm. Likewise, the polymer particles can also have these sizes so that they are sufficiently small to provide about 20 μm to about 150 μm resolution along the x-axis and y-axis (e.g., the axes parallel to the top surface of the powder bed). The x-axis and y-axis resolution will be noticeable at the edges or ends of the printed object at side surfaces during the build. With this in mind, it is notable that in other examples, thicker layers of polymer can be used when high resolution is not demanded, e.g., individual polymer build material layers can be applied at from about 150 μm to about 300 μm, and larger particles can likewise be used as may be practical. Thus, in more practical terms, a range of polymer powder thickness can be from about 20 μm to about 300 μm and/or an average particle size can be from about 10 μm to about 275 μm, with subranges as set forth above.

The polyamide particles or thermoplastic polyamide particles can have a melting temperature from about 70° C. to about 275° C., depending on the specific particles selected for use. In other examples, the polyamide particles or thermoplastic polyamides can have a melting point from about 125° C. to about 250° C., or from about 150° C. to about 200° C. In more specific detail, polyamide-12 particles can have a melting temperature within the range of about 125° C. to about 275° C. or from about 170° C. to about 200° C., for example. Thermoplastic polyamide elastomer (TPA) can have a melting temperature from about 130° C. to about 210° C. or from about 140° C. to about 180° C. On the other hand, various polyamide particles or thermoplastic polyamide particles described herein can have a softening point that is near or relatively distant in temperature from the melting point, ranging from about 60° C. to about 250° C., depending on a variety of factors. Softening point can be determined, for example, using the Vicat method (ASTM-D1525 or ISO 306).

With this in mind, in many examples of the present disclosure, the melting or softening point may not be particularly tied to the temperature of the soaking fluid temperature used. To illustrate by way of Example, a 2 minute to 20 minute soak of a polyamide object in 50 wt % to 100 wt % benzyl alcohol at from about 70° C. to about 120° C. can be effectively used to reduce surface roughness and enhance mechanical properties of the object. As shown in greater detail in the Examples hereinafter, a three-dimensional printed object of thermoplastic polyamide having melting temperature of around 150° C. treated in 100 wt % benzyl alcohol at 80° C. produced an object with about 3 times to about 5 times reduced surface roughness (measured in microns) and also some enhanced mechanical properties. Thus, the use of a soaking fluid with benzyl alcohol at an elevated temperature can provide positive results in a way that may be decoupled from the melting temperature of the polyamide polymer of the three-dimensional object.

### Fusing Agents

Referring now to the fusing agent that can be used in carrying out the methods described herein, such fusing agents can include a radiation absorber that can absorb radiant energy and convert the energy to heat. In certain examples, the fusing agent can be selectively applied to areas of the powder bed of polymer build material that are desired to be consolidated to become part of the solid three-dimensional printed object. The fusing agent can be applied, for example, by printing such as with a fluid ejector or fluid jet print head. Fluid jet print heads can jet the fusing agent in a similar way to an inkjet print head jetting ink. Accordingly, the fusing agent can be applied with great precision to certain areas of the polymer build material that are desired to form a layer of the final three-dimensional printed object. After applying the fusing agent, the powder bed of polymer build material can be irradiated with radiant energy. The radiation absorber from the fusing agent can absorb this energy and convert it to heat, thereby heating the polyamide particles (and in some instances other polymers that may be present) in contact with the radiation absorber. An appropriate amount of radiant energy can be applied so that the area of the polymer build material that was printed with the fusing agent heats up enough to melt the polyamide particles to consolidate the particles into a solid layer, while the polymer build material that was not printed with the fusing agent remains as a loose powder with separate particles.

The amount of radiant energy applied, the amount of fusing agent applied to the powder bed, the concentration of radiation absorber in the fusing agent, and/or the preheating temperature of the powder bed (e.g., the temperature of the polymer build material prior to printing the fusing agent and irradiating) can be tuned to ensure that the portions of the powder bed printed with the fusing agent will be fused to form a solid layer and the unprinted portions of the powder bed will remain a loose powder. These variables can be referred to as parts of the “print mode” of the three-dimensional printing system. The print mode can include any variables or parameters that can be controlled during three-dimensional printing to affect the outcome of the three-dimensional printing process.

The process of forming a single layer by applying fusing agent and irradiating the powder bed can be repeated with additional layers of fresh polymer build material to form additional layers of the three-dimensional printed object, thereby building up the final object one layer at a time. In this process, the polymer build material surrounding the three-dimensional printed object can act as a support material for the object. When the three-dimensional printing is complete, the object can be removed from the powder bed and any loose powder on the object can be removed.

The fusing agent can include a radiation absorber for absorbing electromagnetic radiation and produce heat. The radiation absorber can be colored or colorless. In various examples, the radiation absorber can be a pigment such as carbon black pigment, glass fiber, titanium dioxide, clay, mica, talc, barium sulfate, calcium carbonate, a near-infrared absorbing dye, a near-infrared absorbing pigment, a conjugated polymer, a dispersant, or combinations thereof. Examples of near-infrared absorbing dyes include aminium dyes, tetraaryldiamine dyes, cyanine dyes, pthalocyanine dyes, dithiolene dyes, and others. In other examples, the radiation absorber can be a near-infrared absorbing conjugated polymer such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof. As used herein, “conjugated” refers to alternating double and single bonds between atoms in a molecule. Thus, “conjugated polymer” refers to a polymer that has a backbone with alternating double and single bonds. In many cases, the radiation absorber can have a peak absorption wavelength in the range of about 800 nm to about 1400 nm.

A variety of near-infrared pigments can also be used. Non-limiting examples can include phosphates having a variety of counterions such as copper, zinc, iron, magnesium, calcium, strontium, the like, and combinations thereof. Non-limiting specific examples of phosphates can include M₂P₂O₇, M₄P₂O₉, M₅P₂O₁₀, M₃(PO₄)₂, M(PO₃)₂, M₂P₄O₁₂, and combinations thereof, where M represents a counterion having an oxidation state of +2, such as those listed above or a combination thereof. For example, M₂P₂O₇ can include compounds such as Cu₂P₂O₇, Cu/MgP₂O₇, Cu/ZnP₂O₇, or any other suitable combination of counterions. It is noted that the phosphates described herein can be associated with counterions other than those having a +2 oxidation state. As such, other phosphate counterions can also be used to prepare other suitable near-infrared pigments.

Additional near-infrared pigments can include silicates. Silicates can have the same or similar counterions as phosphates. One non-limiting example can include M₂SiO₄, M₂Si₂O₆, and other silicates where M is a counterion having an oxidation state of +2. For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. It is noted that the silicates described herein can be associated with counterions other than those having a +2 oxidation state. Other silicate counterions can also be used to prepare other suitable near-infrared pigments.

The radiation absorber can include a metal dithiolene complex. Transition metal dithiolene complexes can exhibit a strong absorption band in the 600 nm to 1600 nm region of the electromagnetic spectrum. In some examples, the central metal atom can be any metal that can form square planar complexes. Non-limiting specific examples include complexes based on nickel, palladium, and platinum.

The radiation absorber can include a tungsten bronze or a molybdenum bronze. In certain examples, tungsten bronzes can include compounds having the formula MₓWO₃, where M is a metal other than tungsten and x is equal to or less than 1. Similarly, in some examples, molybdenum bronzes can include compounds having the formula MₓMoO₃, where M is a metal other than molybdenum and x is equal to or less than 1.

The radiation absorber can be selected to provide that the fusing agent is a “low tint fusing agent” that may be transparent, pale in color, or white. For example, the electromagnetic radiation absorber may be transparent or white at wavelengths ranging from about 400 nm to about 780 nm. In some examples, the term “transparent” as used herein, indicates that about 20% or less of the radiation having wavelengths from about 400 nm to about 780 nm is absorbed. Thus, in examples herein, the low tint fusing agent can be white, colorless, or pale in coloration so that coloring agents can be effective in coloring the polymeric polymer build material without much, if any, interference in coloration from the radiation absorber. At the same time, the low tint fusing agent can generate heat when exposed to electromagnetic energy wavelengths from 800 nm to 4,000 nm sufficient to partially or fully melt or coalesce the polymeric polymer build material that is in contact with the low tint fusing agent. In alternative examples, the radiation absorber can preferentially absorb ultraviolet radiation. In some examples, the radiation absorber can absorb radiation in a wavelength range from about 300 nm to about 405 nm. In certain examples, the amount of electromagnetic energy absorbed by the fusing agent can be quantified as follows: a layer of the fusing agent having a thickness of 0.5 μm after liquid components have been removed can absorb from 90% to 100% of radiant electromagnetic energy having a wavelength within a wavelength range from about 300 nm to about 400 nm. The radiation absorber may also absorb little or no visible light, thus making the radiation absorber transparent to visible light. In certain examples, the 0.5 μm layer of the fusing agent can absorb from 0% to 20% of radiant electromagnetic energy in a wavelength range from above about 400 nm to about 700 nm. Non-limiting examples of ultraviolet absorbing radiation absorbers can include nanoparticles of titanium dioxide, zinc oxide, cerium oxide, indium tin oxide, or a combination thereof. In other examples, the ultraviolet radiation absorbers can be in the form of yellow dyes or yellow pigments, which can be beneficial with electromagnetic energy within this wavelength range as well, or more specifically in the range of about 400 nm to about 550 nm, e.g., 455 nm. When the radiation absorber is in the form of dye, it can remain in the three-dimensional printed object as a fine particle when dried. Regarding the nanoparticles, e.g., pigments and other particles, in some examples, the nanoparticles can have an average particle size from about 2 nm to about 300 nm, from about 10 nm to about 100 nm, or from about 10 nm to about 60 nm.

A dispersant can be included in the fusing agent in some examples. Dispersants can help disperse the radiation absorbing pigments described above. In some examples, the dispersant itself can also absorb radiation. Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, and combinations thereof.

The amount of radiation absorber in the fusing agent can vary depending on the type of radiation absorber. For example, the concentration of radiation absorber in the fusing agent can be from about 0.1 wt % to about 20 wt %. In some examples, the concentration of radiation absorber in the fusing agent can be from about 0.1 wt % to about 15 wt %, from about 0.1 wt % to about 8 wt %, from about 0.5 wt % to about 2 wt %, or from about 0.5 wt % to about 1.2 wt %. In other examples, the radiation absorber can have a concentration in the fusing agent such that after the fusing agent is jetted onto the polymer powder, the amount of radiation absorber in the polymer powder can be from about 0.0003 wt % to about 10 wt %, or from about 0.005 wt % to about 5 wt %, with respect to the weight of the polymer powder.

The fusing agent can be jetted onto the polymer build material using a fluid jetting device, such as inkjet printing architecture. Accordingly, the fusing agent can be formulated to give the fusing agent good jetting performance. Ingredients that can be included in the fusing agent to provide good jetting performance can include a liquid vehicle. Thermal jetting can function by heating the fusing agent to form a vapor bubble that displaces fluid around the bubble, and thereby forces a droplet of fluid out of a jet nozzle. Thus, in some examples the liquid vehicle can include a sufficient amount of an evaporating liquid that can form vapor bubbles when heated. The evaporating liquid can be a solvent such as water, an alcohol, an ether, or a combination thereof.

The liquid vehicle formulation can include a co-solvent or co-solvents present in total from about 1 wt % to about 50 wt %, depending on the jetting architecture. Further, a non-ionic, cationic, and/or anionic surfactant can be present, ranging from about 0.01 wt % to about 5 wt %. In some examples, the surfactant can be present in an amount from about 1 wt % to about 5 wt %. The liquid vehicle can include dispersants in an amount from about 0.5 wt % to about 3 wt %. The balance of the formulation can be purified water, and/or other vehicle components such as biocides, viscosity modifiers, materials for pH adjustment, sequestering agents, preservatives, and the like. In some examples, the liquid vehicle can be predominantly water.

A water-dispersible or water-soluble radiation absorber can be used with an aqueous vehicle in some examples. Because the radiation absorber is dispersible or soluble in water, an organic co-solvent may not be present, as it may not be included to solubilize the radiation absorber. Therefore, in some examples the fluids can be substantially free of organic solvent, e.g., predominantly water. However, in other examples, a co-solvent can be used to help disperse other dyes or pigments or to enhance the jetting properties of the respective fluids. In other examples, a non-aqueous vehicle can be used with an organic-soluble or organic-dispersible fusing agent.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol, and/or 1,5-pentanediol.

Regarding the surfactant that may be present, a surfactant or surfactants can be used, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, mixtures thereof, or the like. The amount of surfactant added to the fusing agent may range from about 0.01 wt % to about 20 wt %. Suitable surfactants can include, but are not limited to, liponic esters such as TERGITOL™ 15-S-12, TERGITOL™ 15-S-7, TERGITOL™ 15-S-9 available from Dow Chemical Company (Michigan), LEG-1 and LEG-7; TRITON™ X-100; TRITON™ X-405 available from Dow Chemical Company (Michigan); and sodium dodecylsulfate.

Various other additives can be employed to enhance certain properties of the fusing agent for specific applications. Examples of these additives are those added to inhibit the growth of harmful microorganisms. These additives may be biocides, fungicides, and/or other microbial agents, which can be used in various formulations. Examples of suitable microbial agents include, but are not limited to, NUOSEPT® (Nudex, Inc., New Jersey), UCARCIDE™ (Union carbide Corp., Texas), VANCIDE® (R.T. Vanderbilt Co., Connecticut), PROXEL® (ICI Americas, New Jersey), ACTICIDE® (Thor, United Kingdom), or combinations thereof.

Sequestering agents, such as EDTA (ethylene diamine tetra acetic acid), may be included to eliminate the deleterious effects of heavy metal impurities, and/or buffer solutions may be used to control the pH of the fluid. From about 0.01 wt % to about 2 wt %, for example, can be used. Viscosity modifiers and buffers may also be present, as well as other additives to modify properties of the fluid as desired. Such additives can be present from about 0.01 wt % to about 20 wt %.

The fusing agent can include from about 5 wt % to about 40 wt % organic co-solvent, from about 0 wt % to about 20 wt % high boiling point solvent, from about 0.1 wt % to about 1 wt % surfactant, from about 0.1 wt % to about 1 wt % anti-kogation agent, from about 0.01 wt % to about 1 wt % chelating agent, from about 0.01 wt % to about 1 wt % biocide, and/or from about 1 wt % to about wt % carbon black pigment. The balance can be deionized water.

### Soaking Fluids

The soaking fluid can include from about 50 wt % to 100 wt % benzyl alcohol. If it is something other than 100 wt % benzyl alcohol, the other components present can include water, other alcohols, e.g., C1-C4 alcohols, aromatic alcohols, or other organic cosolvents that may be miscible with water and/or the benzyl alcohol. Benzyl alcohol has moderate solubility in water, e.g., about 4 g/100 mL of water, and is miscible in other alcohols and other organic cosolvents such as diethyl ether.

### Other Fluid Agents

In some more specific examples, the methods can include applying other fluid agents, e.g., other than the fusing agent and/or the soaking fluid. Examples may include a coloring agent and/or a detailing agent. A coloring agent may include, for example, a liquid vehicle and a colorant, such as a pigment and/or a dye. The liquid vehicle can be formulated similarly to that described previously with respect to the fusing agent. In other examples, three-dimensional printing can include the use of a detailing agent. The detailing agent can include a detailing compound. The detailing compound can reduce the temperature of the polymer build material onto which the detailing agent is applied. In some examples, the detailing agent can be printed around the edges of the portion of the powder that is printed with the fusing agent. The detailing agent can increase selectivity between the fused and unfused portions of the powder bed by reducing the temperature of the powder around the edges of the portion to be fused.

The detailing compound can be a solvent that evaporates when it comes into contact with the powder bed at or about the preheat temperature, thereby cooling the printed portion of the powder bed through evaporative cooling. In certain examples, the detailing agent can include water, co-solvents, or combinations thereof. Non-limiting examples of co-solvents for use in the detailing agent can include xylene, methyl isobutyl ketone, 3-methoxy-3-methyl-1-butyl acetate, ethyl acetate, butyl acetate, propylene glycol monomethyl ether, ethylene glycol mono tert-butyl ether, dipropylene glycol methyl ether, diethylene glycol butyl ether, ethylene glycol monobutyl ether, 3-Methoxy-3-Methyl-1-butanol, isobutyl alcohol, 1,4-butanediol, N,N-dimethyl acetamide, or combinations thereof. In some examples, the detailing agent can be mostly water. In other examples, the detailing agent can be about 85 wt % water or more or about 95 wt % water or more. In other examples, the detailing agent can be substantially devoid of radiation absorbers. That is, in some examples, the detailing agent can be substantially devoid of ingredients that absorb enough radiation energy to cause the powder to fuse. In certain examples, the detailing agent can include colorants such as dyes or pigments, but in small enough amounts that the colorants do not promote fusion of the polymer build material printed with the detailing agent when exposed to the radiation energy. The detailing agent can also include ingredients to allow the detailing agent to be jetted by a fluid jet printhead. In some examples, the detailing agent can include jettability imparting ingredients such as those in the fusing agent described above. These ingredients can include a liquid vehicle, surfactant, dispersant, co-solvent, biocides, viscosity modifiers, materials for pH adjustment, sequestering agents, preservatives, mixtures thereof, etc. These ingredients can be included in any of the amounts described above.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, “kit” can be synonymous with and understood to include a plurality of multiple components where the different components can be separately contained (though in some instances co-packaged in separate containers) prior to use, but these components can be combined together during use, such as during the three-dimensional object build processes described herein. The three-dimensional objects and methods can be carried out using a three-dimensional printing kit, for example, that includes the polymer build material, the fusing agent, and the soaking fluid, for example, among other possible fluids or materials that may be included. The containers used to carry the kit components can be any type of a vessel, box, or receptacle made of any material.

As used herein, “applying” when referring to a fluid agent that may be used, for example, refers to any technology that can be used to put or place the fluid, e.g., polymer build material, fusing agent, detailing agent, coloring agent, or the like on the polymeric build material or into a layer of polymeric build material for forming a three-dimensional object. For example, “applying” may refer to a variety of dispensing technologies, including “jetting,” “ejecting,” “dropping,” “spraying,” or the like.

As used herein, “jetting” or “ejecting” refers to fluid agents or other compositions that are expelled from ejection or jetting architecture, such as ink-jet architecture. Ink-jet architecture can include thermal or piezoelectric architecture. Additionally, such architecture can be configured to print varying drop sizes such as up to about 20 picoliters, up to about 30 picoliters, or up to about 50 picoliters, etc. Example ranges may include from about 2 picoliters to about 50 picoliters, or from about 3 picoliters to about 12 picoliters.

As used herein, “average” when referring to numerical ranges such as particle size refers to a number average of the diameter of the particles for spherical particles, or a number average of the volume equivalent sphere diameter for non-spherical particles. The volume equivalent sphere diameter is the diameter of a sphere having the same volume as the particle. Average particle size can be measured using a particle analyzer such as the MASTERSIZER™ 3000 available from Malvern Panalytical (United Kingdom). The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can analyze the angular scattering data to calculate the size of the particles using the Mie theory of light scattering. The particle size can be reported as a volume equivalent sphere diameter.

As used herein, a plurality of items, structural elements, compositional elements, and/or materials may be presented in a common list for convenience. However, these lists should be construed as though the individual member of the list is identified as a separate and unique member. Thus, no individual member of such list should be construed as a de facto equivalent of any other member of the same list based on presentation in a common group without indications to the contrary.

Concentrations, dimensions, amounts, and/or other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. However, it is to be understood that the following are merely illustrative of the application of the principles of the present disclosure. Numerous modifications and alternative objects, methods, devices, systems, etc., may be devised without departing from the spirit and scope of the present disclosure. The appended claims are intended to cover such modifications and arrangements.

### Example 1—Preparation of Three-dimensional Printed Objects

A series of sample three-dimensional objects were printed using an HP Jet Fusion 3D® printer in the shape dog bones (Type S2 in accordance with DIN 53504:2009-10). The build material was 100 wt % thermoplastic polyamide particles having an average particle size from about 60 μm to about 85 μm and a melting temperature from about 145° C. to about 155° C. The fusing agent used included about 5 wt % carbon black pigment as the radiation absorber. Once prepared, all of the dog bones prepared were lightly sandblasted to remove any residual white loose powder at or around the surface. Notably, the sandblasting did not significantly impact surface roughness.

### Example 2—Surface Roughness Comparison

Two (2) Type S2 dog bones prepared in accordance with Example 1 (Control Dog Bone 1 and Control Dog Bone 2). Each dog bone was measured for surface roughness at six sample locations each (three locations at a top of the dog bone and three locations at a bottom of the dog bone). The six locations were selected at the bottom and the top of the dog bone because the bottom portions of the dog bone (deeper in the powder bed material) can be subjected to more prolonged (and sometimes greater) heat during a build because they are present in the powder bed for a longer period of time. Surface roughness was measured using a Mitutoyo surface roughness gauge, which measures the surface roughness in microns (μm). The data collected is provided in Table 1, as follows:

TABLE 1
Control Dog Bones
Surface Roughness (microns)

| | Roughness at Top | Roughness at Bottom |
|---|---|---|
| | (μm) | (μm) |
| Control Dog Bone 1 | 12.778 | 11.434 |
| | 13.111 | 11.223 |
| | 12.426 | 11.167 |
| Control Dog Bone 2 | 12.584 | 11.119 |
| | 13.660 | 11.045 |
| | 13.012 | 10.747 |

Three (3) Type S2 dog bones prepared in accordance with Example 1 were also prepared and each was individually placed in a soaking fluid of 100 wt % benzyl alcohol for about 10 minutes at about 80° C. (Dog Bone 1, Dog Bone 2, and Dog Bone 3). The soaking procedure included placing the dog bone in a glass jar, which was then filled with benzyl alcohol until it was fully submerged. The glass jar was placed in an 80° C. oven for about 10 minutes. After removing the glass jar from the oven, the dog bones were removed from their respective soaking fluid and taken out of the jar and placed on aluminum foil to allow for cooling to room temperature. Once cooled, the excess benzyl alcohol was wiped from the surface of the part followed by taking the surface roughness measurements as outlined above (using a Mitutoyo surface roughness gauge). The data collected is provided in Table 2, as follows:

TABLE 2
Dog Bones after Soaking Fluid Treatment
Surface Roughness (microns)

| | Roughness at Top | Roughness at Bottom |
|---|---|---|
| | (μm) | (μm) |
| Dog Bone 1 | 4.288 | 3.830 |
| (after Soaking Fluid) | 4.048 | 3.948 |
| | 4.082 | 4.036 |
| Dog Bone 2 | 3.130 | 4.371 |
| (after Soaking Fluid) | 3.357 | 4.508 |
| | 3.862 | 3.964 |
| Dog Bone 3 | 2.038 | 1.201 |
| (after Soaking Fluid) | 1.839 | 2.186 |
| | 2.527 | 1.799 |

As can be seen in Table 2, the surface roughness was considerably smoothed by soaking the dog bones of Table 1 in benzyl alcohol at 80° C. for about 10 minutes. The roughness at both the top and the bottom of the printed dog bones was about 3 to about 5 times better (based on microns) after soaking compared to the dog bones that were not soaked in benzyl alcohol, but which were otherwise prepared using an identical process.

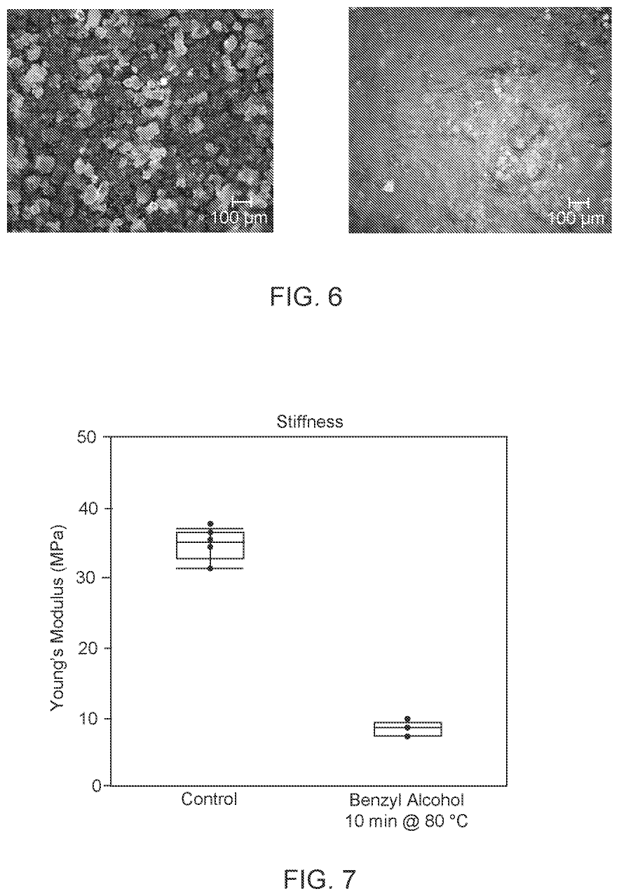

To provide a visual comparison, an optical micrograph imaging is shown in FIG. 6 at one location from one of the Control Dog Bones (A) and one of the Dog Bones after being subjected to the soaking fluid of benzyl alcohol (B). As can be seen, the Dog Bones soaked with benzyl alcohol at an elevated temperature was considerably smoother in appearance compared to one of the Control Dog bones.

### Example 3—Mechanical Properties Comparison

Type S2 dog bones prepared in accordance with Example 1 were evaluated for overall stiffness, ductility or elongation, and tensile strength both without (control) and with a 10 minute, 80° C., 100 wt % benzyl alcohol soak, as outlined in the procedure of Example 2.

As shown in FIG. 7, the stiffness or elastic modulus (or Young's modulus) of the various three-dimensional printed objects were tested using an INSTRON® Tensile Tester, from Instron (USA). As shown, the overall stiffness was reduced after subjecting the dog bones to the soaking fluid, with about a 3× to about 4× reduction, which can be favorable for many applications benefitting from more flexible parts.

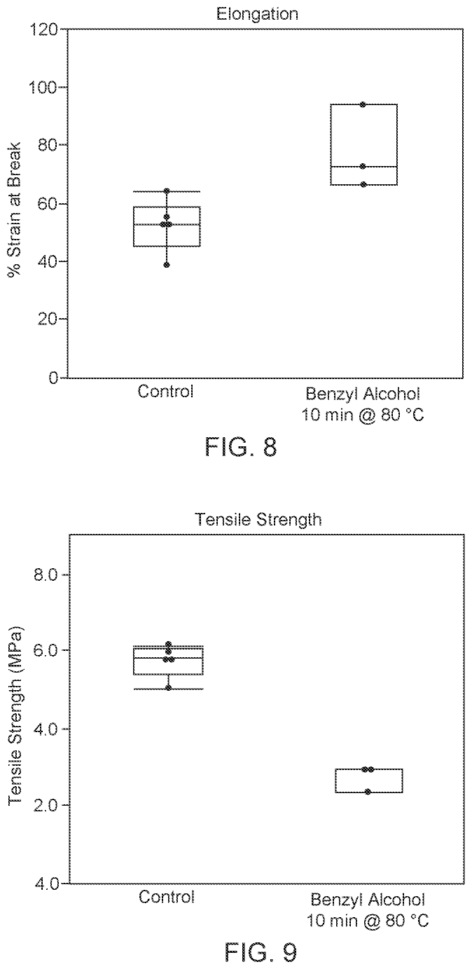

As shown in FIG. 8, ductility or elongation at break was likewise compared. Ductility refers to the ability of a material to be drawn out by a tensile force without breaking. Ductile materials may be drawn to a longer length and a narrower cross-section by a tensile force with fracturing. Materials with a higher ductility can have a higher strain at the breaking point. The strain at break was measured using an INSTRON® Tensile Tester, available from Instron (USA).

As shown in FIG. 9, treatment using the soaking fluid in this example appeared to reduce tensile strength, though there may be other times and temperature profiles that could minimize this effect. In some applications, this could be insignificant, and in other applications, there may be limitations where tensile strength is a valuable property to achieve. Other treatments could be used to enhance this property if that is desirable. This testing was also conducted using an INSTRON® Tensile Tester, from Instron (USA).

What is claimed is:

1. A three-dimensional printed object comprising:
a fused polyamide body having electromagnetic radiation absorber embedded as particles within the fused polyamide body; and
residual benzyl alcohol soaked into a surface of the polyamide body.

2. The three-dimensionally printed object of claim 1, wherein the electromagnetic radiation absorber is selected from carbon black pigment, metal dithiolene complex, a near-infrared absorbing dye, a near-infrared absorbing pigment, metal nanoparticles, a conjugated polymer, tungsten bronze, molybdenum bronze, or a combination thereof.

3. The three-dimensionally printed object of claim 1, wherein the fused polyamide body includes polyamide-6, polyamide-9, polyamide-11, polyamide-12, polyamide-6,6, polyamide-6,12, thermoplastic polyamide, amorphous polyamide, thermoplastic polyamide, polyamide copolymer, e.g., polyvinylidene fluoride copolyamide-12, or a combination thereof.

4. The three-dimensionally printed object of claim 1, wherein three-dimensional printed object has a surface roughness from about 1 μm to about 8 μm.

5. A method of enhancing smoothness of a three-dimensional printed object comprising soaking a three-dimensional printed object in a soaking fluid including from about 50 wt % to 100 wt % benzyl alcohol at a temperature from about 50° C. to about 205° C. for a period of time of about 10 seconds to about 15 minutes, wherein the three-dimensional printed object includes a fused polyamide body and electromagnetic radiation absorber particles dispersed within the fused polyamide body.

6. The method of claim 5, wherein the electromagnetic radiation absorber particles are selected from carbon black pigment, metal dithiolene complex, a near-infrared absorbing dye, a near-infrared absorbing pigment, metal nanoparticles, a conjugated polymer, tungsten bronze, molybdenum bronze, or a combination thereof.

7. The method of claim 5, wherein the fused polyamide body includes polyamide-6, polyamide-9, polyamide-11, polyamide-12, polyamide-6,6, polyamide-6,12, thermoplastic polyamide, amorphous polyamide, thermoplastic polyamide, polyamide copolymer, e.g., polyvinylidene fluoride copolyamide-12, or a combination thereof.

8. The method of claim 5, wherein prior to soaking, the three-dimensional printed object has a surface roughness from about 10 to about 20 prior to soaking, and after soaking the three-dimensional object has a surface roughness from about 1 μm to about 8 μm.

9. The method of claim 5, wherein after soaking, the three-dimensional printed object has a reduced stiffness and an enhanced elongation at break after soaking relative to prior to soaking.

10. The method of claim 5, wherein residual benzyl alcohol is soaked into a surface of the three-dimensional printed object.

11. A method of three-dimensional printing comprising:
iteratively applying individual polymer build material layers of polyamide particles to a powder bed;
based on a three-dimensional object model, selectively applying a fusing agent onto the individual polymer build material layers, wherein the fusing agent comprises water and an electromagnetic radiation absorber;
exposing the powder bed to electromagnetic energy to selectively fuse the polyamide particles in contact with the electromagnetic radiation absorber to form the fused polyamide body having the electromagnetic radiation absorber particles dispersed therein; and
soaking the fused polyamide body in a soaking fluid including benzyl alcohol to form a smoothed three-dimensional printed object.

12. The method of claim 11, wherein soaking fluid includes from about 50 wt % to 100 wt % benzyl alcohol.

13. The method of claim 11, further comprising washing the surface of the three-dimensional printed object after soaking.

14. The method of claim 11, wherein residual benzyl alcohol is soaked into a surface of the three-dimensional printed object.

15. The method of claim 11, wherein the fused polyamide body has a surface roughness from about 10 to about 20 prior to soaking, and after soaking the three-dimensional object has a surface roughness from about 1 μm to about 8 μm.
